(19) United States
(12) Patent Application Publication
(10) Pub. No.: US 2021/0041257 A1
(43) Pub. Date: Feb. 11, 2021

(54) Method, Apparatus, Computer Device and Readable Storage Medium for Processing Position Information

(71) Applicant: Beijing Baidu Netcom Science and Technology Co., Ltd., Beijing (CN)

(72) Inventors: Yanyan Li, Beijing (CN); Jianguo Duan, Beijing (CN); Hui Xiong, Beijing (CN)

(21) Appl. No.: 16/813,782

(22) Filed: Mar. 10, 2020

(30) Foreign Application Priority Data
Aug. 8, 2019 (CN) 201910731620.5

(51) Int. Cl. G01C 21/34; G08G 1/01; G08G 1/00

(52) U.S. Cl. CPC G01C 21/3484; G08G 1/0129; G01C 21/3492; G01C 21/3461; G08G 1/20

(57) ABSTRACT

A method, an apparatus, a computer device and a readable storage medium for processing a position information are provided, the method including: determining a region sequence according to a movement trajectory of a user; counting a user traffic between two position regions included in a target region key-value pair; calculating a public transport efficiency value according to the target region key-value pair; and determining a public transport resource satisfaction degree of the target region key-value pair according to the public transport efficiency value and the user traffic. A computer processes and calculates based on collected user trajectories without the need for investigators to visit, thereby reducing labor costs. In addition, the user trajectories are processed to obtain a public transport resource satisfaction degree between two regions, and the data processing by the computer may avoid manual statistics of investigation results.

### CROSS-REFERENCE TO RELATED APPLICATION

This application claims priority to Chinese Patent Application No. 201910731620.5 filed Aug. 8, 2019, the disclosure of which is hereby incorporated by reference in its entirety.

### TECHNICAL FIELD

Embodiments of the present disclosure relate to a public transport technology, and specifically to a method, an apparatus, a computer device and a readable storage medium for processing a position information.

### BACKGROUND

Before planning a bus route, a bus company needs to know which routes are in demand, and then plans bus routes for the routes that are in demand.

At present, a questionnaire survey is generally used to obtain route needs. The questionnaire survey is to issue questionnaires to local residents. In the questionnaires, several alternative routes are provided for residents for selection, and the residents may choose the alternative routes that they expect to open. After the residents fill in the questionnaires, the bus company collects the questionnaires and counts the number of ticked alternative routes. A counting result is used to indicate the degree of demand for each alternative route.

However, in such method, the questionnaires are filled by local residents according to their subjective feelings, and the collected results are often not accurate enough. Meanwhile, investigators need to visit each township, which is costly and inefficient.

### BRIEF DESCRIPTION OF THE DRAWINGS

FIG. 1 is a flowchart of a method for processing a position information according to embodiment 1 of the present disclosure;

FIG. 2 is a flowchart of a method for processing a position information according to embodiment 2 of the present disclosure;

FIG. 3 is a flowchart of a method for processing a position information according to embodiment 3 of the present disclosure;

FIG. 4 is a flowchart of a method for processing a position information according to embodiment 4 of the present disclosure;

FIG. 5 is a schematic structural diagram of an apparatus for processing a position information according to embodiment 5 of the present disclosure; and

FIG. 6 is a schematic structural diagram of a computer device according to embodiment 6 of the present disclosure.

### DETAILED DESCRIPTION OF EMBODIMENTS

Embodiments of present disclosure will be described below in detail with reference to the accompanying drawings and embodiments. It should be appreciated that the specific embodiments described herein are merely used for explaining the present disclosure, rather than limiting the present disclosure. In addition, it should be noted that, for the ease of description, only the parts associated with the present disclosure rather than the whole structure are shown in the accompanying drawings.

### Embodiment 1

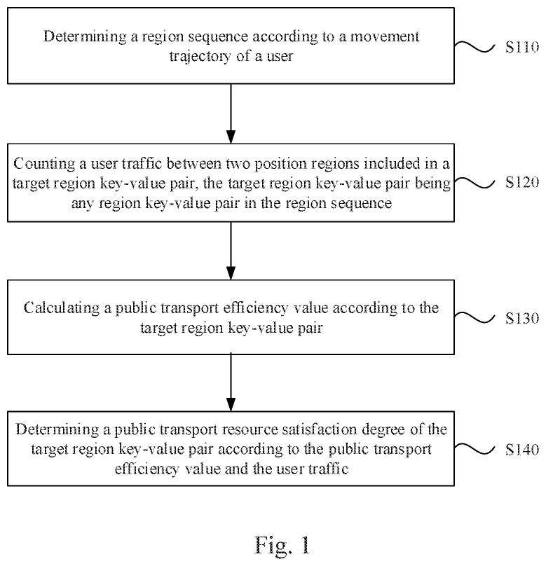

FIG. 1 is a flowchart of a method for processing a position information according to embodiment 1 of the present disclosure. The present embodiment may be applied to quantify a public transport resource satisfaction degree. The method may be executed by a computer device, and the computer device may be a server or a workstation and the like. The method specifically includes the following steps.

Step 110: determining a region sequence according to a movement trajectory of a user.

The region sequence includes multiple region key-value pairs, and each region key-value pair represents two position regions through which the user passes.

The movement trajectory of the user includes multiple pieces of coordinate information of the user and time information of the user in the coordinate information. A region through which a user passes may be determined according to a movement trajectory of the user, and a region sequence may be determined according to the regions through which the user passes. The region sequence includes multiple region key-value pairs, and two adjacent region key-value pairs have an overlapping position region, and then the movement order of the user between regions may be obtained based on the overlapping position region. The format of the region key-value pair may be (first region, second region), which indicates that the user moves from the first region to the second region.

The movement trajectory of the user is continuous, so the regions that the user passes through are multiple adjacent regions, and every two adjacent regions may be used as a region key-value pair. The adjacent regions may be geographically adjacent, for example, an east region of a shopping mall and a west region of the shopping mall. In addition, the adjacent regions may alternatively be two physically discontinuous position regions to which the user has moved one after another, for example, two independent buildings that are close to each other.

Each region key-value pair is used to represent a travel demand of the user. For example, if the movement trajectory of the user is that the user passes through a region A, a region B and a region C, a region key-value pair (region A, region B) and a region key-value pair (region B, region C) may be obtained. The region key-value pair (region A, region B) represents the travel demand of the user for moving from the region A to the region B, while the region key-value pair (region B, region C) represents the travel demand of the user for moving from the region B to the region C.

The user trajectories of multiple users may be collected, and then region sequences corresponding to the user trajectories are calculated respectively. Each user is associated with a region sequence obtained based on the user trajectory. When a public transport survey is performed, the user trajectories obtained may be filtered based on a target region of such survey, and movement trajectories within the target region are retained. The target region may be a block, a city, a province, or a country.

Step 120: counting a user traffic between the two position regions included in the target region key-value pair, the target region key-value pair being any region key-value pair in the region sequence.

The region key-value pair is used to represent a travel demand of the user. A public transport resource satisfaction degree may be calculated for any one of the region key-value pairs in the region sequence obtained in step 110. For the convenience of description, any region key-value pair in the region sequence is called as a target region key-value pair. A public transport resource satisfaction degree is calculated for each region key-value pair in the region sequence, and then a public transport resource satisfaction degree between region nodes in the region sequence is obtained.

When the region sequence corresponding to the user trajectory includes the target region key-value pair, it means that the user with the user trajectory also passes through the two regions included in the target region key-value pair, and the movement order is the same as an order described in the target key-value pair. Therefore, the number of user trajectories including the target region key-value pair may be counted, and this number may be used as a user traffic between the two position regions included in the target region key-value pair.

Specifically, the number may be obtained in the following ways.

1) Determining whether a region key-value pair matching the target region key-value pair is included in a region sequence of other users.

Other users correspond to user trajectories other than the currently selected target region key-value pair among the received user trajectories. A region sequence of other users is read, and region key-value pairs in the region sequence are read respectively. The read region key-value pairs are compared with a target region key-value pair, and whether the read region key-value pairs are the same as the target region key-value pair is determined. If they are the same, it is determined that a region key-value pair matching the target region key-value pair is included in the current region sequence of the other users; otherwise, it is determined that a region key-value pair matching the target region key-value pair is not included in the current region sequence of the other users.

2) If the region key-value pair matching the target region key-value pair is included in the region sequence of other users, counting to obtain a counting result, the counting result being used to indicate the number of users who have travel demands for the target region key-value pair.

A count variable may be configured. When it is determined that the region key-value pair matching the target region key-value pair is included in the region sequence of other users, 1 is added to the count variable, and then the sum of region sequences having region key-value pairs matching the target region key-value pair is count, the sum being a user traffic between the two position regions included in the target region key-value pair. The embodiment above may quickly identify and count the number of records including the target key-value pair based on the received user trajectories, thereby counting the user traffic more accurately and efficiently.

Step 130: calculating a public transport efficiency value according to the target region key-value pair.

The public transport efficiency value is used to indicate the use efficiency of existing public transport resources. The public transport efficiency value may be the ratio of the existing public transport resources to ideal transport resources. The existing public transport resources may be the time taken for a user to use public transport resources when moving between the two regions included in the target region key-value pair. The ideal transportation resources refer to the time (excluding the time spent due to delay factors such as transfer and waiting) taken for a user to use a non-stop vehicle for moving between the two regions included in the target region key-value pair.

It should be noted that step 120 is used to count the user traffic, and step 130 is used to calculate the public transport efficiency value. Steps 120 and 130 are performed in any order, or may be performed in parallel. For example, such steps are distributed to multiple distributed computing servers for calculation.

Step 140: determining a public transport resource satisfaction degree of the target region key-value pair according to the public transport efficiency value and the user traffic.

As the user traffic increases, the shortcomings of public transport resources are magnified. Therefore, the product of the public transport efficiency value and the user traffic may be used as the public transport resource satisfaction degree of the target region key-value pair. The public transport efficiency value and the user traffic have different degrees of attention in different regions. Therefore, a first weight may be assigned to the public transport efficiency value, and a second weight may be assigned to the user traffic. The product A of the first weight and the public transport efficiency value is calculated, the product B of the second weight and the user traffic is calculated, and the product A is multiplied with the product B to obtain the public transport resource satisfaction degree of the target region key-value pair. The first weight and the second weight may be adjusted according to the degrees of attention to different factors in a region, and the first weight and the second weight are greater than 0. For example, when more attention is paid to the public transport efficiency value, the first weight may be increased to be greater than the second weight. For example, the first weight is set to be greater than 1, and the second weight is set to be smaller than 1.

Optionally, the product of the public transport efficiency value and the user traffic is calculated, and the product is used as the public transport resource satisfaction degree of the target region key-value pair. In order to more objectively reflect the public transport resources in a region so that a public transport management department may know the public transport resources in such region more accurately, both the first weight and the second weight are set as 1. The product of the public transport efficiency value and the user traffic is used as the public transport resource satisfaction degree of the target region key-value pair.

The method for processing a position information provided by the present embodiment of the present disclosure may: determine a region sequence according to a movement trajectory of a user, the region sequence including multiple region key-value pairs; count a user traffic between two position regions included in a target region key-value pair; then, calculate a public transport efficiency value according to the target region key-value pair; and finally determine a public transport resource satisfaction degree of the target region key-value pair according to the public transport efficiency value and the user traffic. A computer performs processing and calculation based on collected user trajectories without visiting of the investigators, thereby reducing labor costs. In addition, the user trajectories are processed to obtain a public transport resource satisfaction degree between two regions, and the data processing by the computer may avoid manual statistics of investigation results, thereby improving the processing speed. Meanwhile, since the public transport resource satisfaction degree is determined according to the user trajectories, it is possible to calculate a traffic demand degree using real behavior data, thereby improving the accuracy of the public transport resource satisfaction degree.

### Embodiment 2

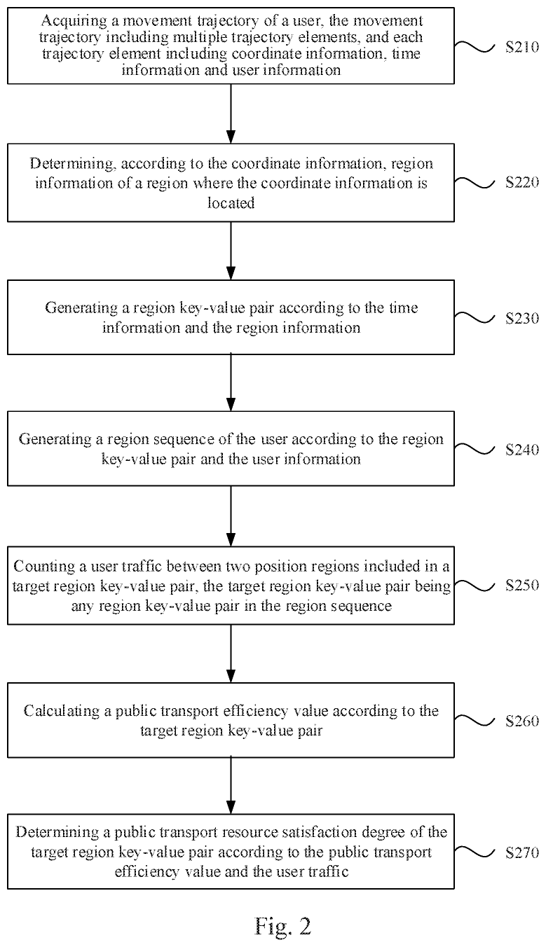

FIG. 2 is a flowchart of a method for processing a position information according to embodiment 2 of the present disclosure. As a further description of the foregoing embodiment, the method includes.

Step 210: acquiring a movement trajectory of a user, the movement trajectory including multiple trajectory elements, and each trajectory element including coordinate information, time information and user information.

The present embodiment may be executed in a server, and the server receives user positioning data sent by a terminal. The terminal may send the user positioning data of the user to the server at a preset time interval (for example, every one hour). The user positioning data may be multiple pieces of new positioning data obtained by calculation following a previously transmitted movement trajectory. After receiving the user positioning data, the server stitches the new positioning data with a stored movement trajectory to obtain a complete movement trajectory of the user.

A time interval may be determined according to a target duration of a survey, and a user trajectory within such time interval may be intercepted according to the time interval. For example, if a target duration of a survey is three days from August 1 to August 3, the server records and updates the movement trajectories of each user within these three days.

The user positioning data may be obtained by means of GPS, or obtained by means of WiFi to which the terminal is connected, or determined based on a base station to which the user is connected.

In achieving above solution, it likely happens that for transmitting the user positioning data at a preset time interval, the sleeping terminal is started to transmit the user positioning data, causing unnecessary waste of resources. Therefore, when the frequency of operating the terminal by the user reaches a threshold, the user positioning data transmitted by the terminal may be received, and the movement trajectory of the user is updated according to the user positioning data.

The frequency of operating the terminal by the user may be the frequency clicking a touch screen of the terminal by the user, or the shaking frequency of sensing shake or the like of a user by an acceleration sensor in the terminal. When the frequency of operating the terminal by the user reaches the threshold, the terminal transmits user positioning data to the server, which may reduce the power consumption of the terminal and improve the use efficiency of terminal.

Step 220: determining, according to the coordinate information, region information of a region where the coordinate information is located.

The user positioning data may only provide coordinate points where the user is located at different times. However, the user may stay or interact within a certain range for a period of time. In this case, even if coordinate information is different, but the user does not actually move and has no demand for public transport at this time. Therefore, the coordinate information may be associated with the region information by means of indexing. For example, when the user moves inside an office building, the region information of the office building keeps unchanged. The coordinate information may be mapped to the region information by means of Geohash or a spatial index algorithm based on geometric operations, so as to obtain region information corresponding to each coordinate information.

Step 230: generating a region key-value pair according to the time information and the region information.

Pieces of region information for regions where the user is located in turn may be sorted according to the time information. For example, the pieces of the region information corresponding to the time information may be acquired in an ascending order of pieces of the time information. If pieces of the region information is different, a region key-value pair is generated based on two pieces of different region information. If pieces of the region information are the same, a piece of region information corresponding to a next piece of time information is read until two pieces of different region information are acquired, and then a region key-value pair is generated.

Step 240: generating a region sequence of the user according to the region key-value pair and the user information.

The region sequence includes multiple region key-value pairs, and each region key-value pair represents two position regions through which the user passes.

A region sequence is generated for each piece of user information. Region key-value pairs are sorted according to the time information so as to obtain a region sequence.

Step 250: counting a user traffic between two position regions included in a target region key-value pair, the target region key-value pair being any region key-value pair in the region sequence.

Step 260: calculating a public transport efficiency value according to the target region key-value pair.

Step 270: determining a public transport resource satisfaction degree of the target region key-value pair according to the public transport efficiency value and the user traffic.

The method for processing a position information provided by the present embodiment of the present disclosure may: acquire a movement trajectory of a user; determine, according to the coordinate information included in the trajectory information, region information of a region where the coordinate information is located; generate a region key-value pair according to the time information and the region information; and generate a region sequence of the user according to the region key-value pair and the user information, so as to generate the region sequence based on the real movement trajectory of the user, thereby generating the region sequence that accurately identifies the movement trajectory of the user based on the actual positioning data of the user and improving the accuracy.

### Embodiment 3

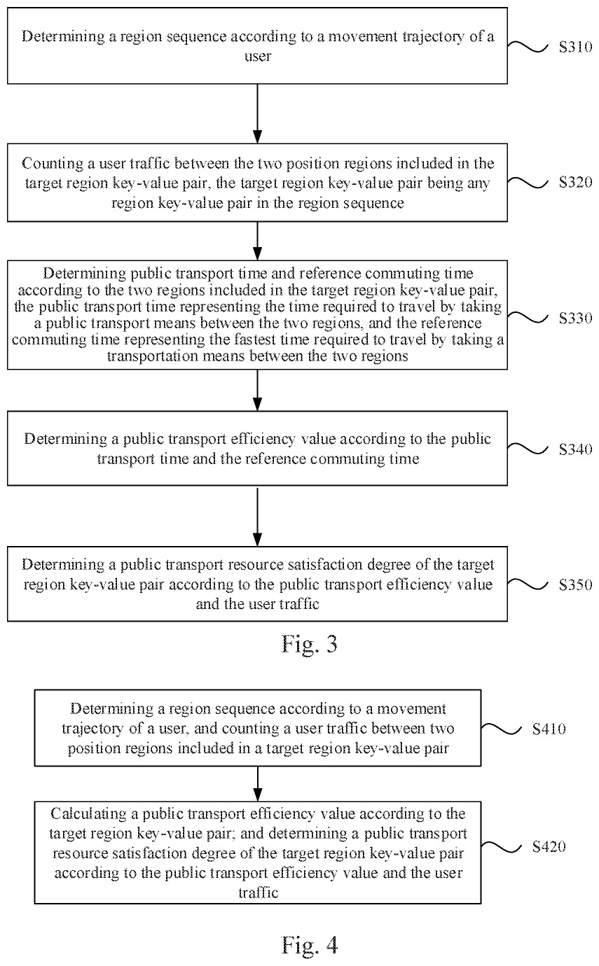

FIG. 3 is a flowchart of a method for processing a position information according to embodiment 3 of the present disclosure. As a further description of the foregoing embodiment, the method includes:

Step 310: determining a region sequence according to a movement trajectory of a user.

The region sequence includes multiple region key-value pairs, and each region key-value pair represents two position regions that the user passes through.

Step 320: counting a user traffic between the two position regions included in the target region key-value pair, the target region key-value pair being any region key-value pair in the region sequence.

Step 330: determining public transport time and reference commuting time according to the two regions included in the target region key-value pair, the public transport time representing the time required to travel by taking a public transport means between the two regions, and the reference commuting time representing the fastest time required to travel by taking a transportation means between the two regions.

After the two regions included in the target region key-value pair are determined, the two regions are used as start and end points respectively. The time taken from the starting point to the end point along a public transport route is calculated and is used as public transport time. The public transport route includes a combination of one or more of a bus route, a subway route and a walking route. If there are multiple public transport routes, the shortest time of respective times spent on the multiple routes or the average time of respective times spent on the multiple routes may be used as the public transport time.

Optionally, the fastest time in history between the starting point and the end point is retrieved, and this time is used as reference commuting time. Alternatively, the time taken to drive is calculated and used as the reference commuting time.

Further, in order to calculate the commuting time between regions more accurately, the steps above may also be implemented in the following ways.

Determining a public transport route and a reference commuting route according to a center point of the two regions included in the target region key-value pair; and determining public transport time according to the public transport route; and determining reference commuting time according to the reference commuting route.

Calculating coordinates of the center points of the two regions respectively, and taking the two center points as starting and ending points respectively; and determining a public transport route and a reference commuting path according to the starting and ending points.

Optionally, the center point of the two regions is inputted into a navigation application as the starting and ending points by means of an application interface. The navigation application may plan a public transport route and the public transport time required for the public transport route according to the starting and ending points. The navigation application may also plan a driving route and the driving time required for the driving route according to the starting and ending points. The driving time may be used as the reference commuting time.

Step 340: determining a public transport efficiency value according to the public transport time and the reference commuting time.

Optionally, the ratio of the public transport time to the reference commuting time is used as a public transport efficiency value.

Step 350: determining a public transport resource satisfaction degree of the target region key-value pair according to the public transport efficiency value and the user traffic.

The method for processing a position information provided by the present embodiment of the present disclosure may accurately calculate the public transport time and the reference commuting time according to two regions included in the target region key-value pair, thereby improving the accuracy of the public transport efficiency value.

### Embodiment 4

Step 410: determining a region sequence according to a movement trajectory of a user, and counting a user traffic between two position regions included in a target region key-value pair.

The movement trajectory of the user may be expressed as, where, uᵢ refers to a user identifier and is used to identify a user uniquely, t1, t2 . . . tn refer to time information when position information is acquired, locₜ_{₁} refers to position information at the time of t₁, locₜ_{₂} refers to position information at the time of t₂, and locₜ_{ₙ} refers to position information at the time of tn.

First, an input T is grid-coded according to locₜ_{ₙ}, and geohash or a spatial index algorithm based on geometric operations is used to associate point position information locₜ_{ₙ} with region information region, so as to generate a region staying sequence R of the user:

R={(uᵢ,t₁,regionₜ_{₁}),(uᵢ,t₂,regionₜ_{₂}), . . . ,(uᵢ,tₙ,regionₜ_{ₙ})}

Where, regionₜ_{₁} indicates the region information where the user uᵢ is located at the time of t₁.

Secondly, generating a region sequence based on the region staying sequence of the user.

Based on an inter-region staying sequence of the user, generating multiple region key-value pairs: (regionₜ_{₁},regionₜ_{₂}. (regionₜ_{₂}, regionₜ_{₃}) . . . , (regionₜ_{ₙ₋₁}, regionₜ_{ₙ}).

Where, (regionₜ_{₁},regionₜ_{₂}) refers to the user moving from regionₜ_{₁} to regionₜ_{₂}. Each region key-value pair represents a travel demand of the user.

Thirdly, counting a trip frequency corresponding to each region key-value pair, that is, determining whether a region key-value pair matching the target region key-value pair exists in a region sequence of other users; and if the region key-value pair matching the target region key-value pair exists, counting to obtain a counting result:
(region₁, region₂, num_{1,2}) (region₃, region₄, num_{3,4}), . . . , (regioₙ₋₁,regionₙ,num_{n-1,n})

Where, num1,2 is the number of region sequences with (region₁, region₂) and is used to represent the number of users traveling between the two regions (region₁, region₂).

Step 420: calculating a public transport efficiency value according to the target region key-value pair; and determining a public transport resource satisfaction degree of the target region key-value pair according to the public transport efficiency value and the user traffic.

Firstly, assuming that the target region key-value pair is (region₁, region₂), and calculating public transport time cost_{bus} and reference commuting time cost_{car} between the region₁ and the regionⱼ.

cost_{bus}=bus(regionᵢ,regionⱼ)

cost_{car}=car(regionᵢ,regionⱼ)

Here, the function bus represents the time spent on a public transport means under the shortest choice between the regionᵢ and the region, and the function car represents the time spent on a public transport means under the shortest choice between the regionᵢ and regionⱼ. The two functions may be implemented by calling the functions in the navigation application.

Then, determining a public transport efficiency value according to the divisor of the public transport time and the reference commuting time.

e_{i,j}=cost_{car}/cost_{bus}

For example, cost_{bus}=bus(regionᵢ,regionⱼ) is 40 min, cost_{car}=car(regionᵢ,regionⱼ) is 14 min, e=cost_{car}/cost_{bus}=14/40=0.35, and cost_{bus} and cost_{car} are identical approximately where a bus route is absent from transfer and walking. In a real-world scene, the public transport often needs to take more waiting and transfer time. The public transport resource satisfaction degree is defined as extra time cost. In order to facilitate normalization, and such degree is defined as the ratio of the time spent on a car to the time spent on a bus where the time and starting and ending points are the same.

Finally, calculating a public transport resource satisfaction degree Q between the regionᵢ and regionⱼ according to the (region₁, region₂, num_{1,2}), (region₃,region₄,num_{3,4}), . . . , (regionₙ₋₁,regionₙ,num_{n-1,n}), regionᵢ, regionⱼ and e_{i,j}: Q=num_{i,j}*e_{i,j}

The public transport resource satisfaction degree Q integrates the needs of the user between the regions for public transport and the public transport supply capacity between the regions, and may comprehensively reflect the satisfaction of residents between the regions with the public transport resources.

The method for processing a position information provided by the present embodiment of the present disclosure may: determine a region sequence according to a movement trajectory of a user, the region sequence including multiple region key-value pairs; count a user traffic between two position regions included in a target region key-value pair; then, calculate a public transport efficiency value according to the target region key-value pair; and finally determine a public transport resource satisfaction degree of the target region key-value pair according to the public transport efficiency value and the user traffic. A computer processes and calculates based on collected user trajectories without the need for investigators to visit, thereby reducing labor costs. In addition, the user trajectories are processed to obtain a public transport resource satisfaction degree between two regions, and the data processing by the computer may avoid manual statistics of investigation results, thereby improving the processing speed. Meanwhile, since the public transport resource satisfaction degree is determined according to the user trajectories, it is possible to calculate a traffic demand degree using real behavior data, thereby improving the accuracy of the public transport resource satisfaction degree. Compared with the questionnaire method, this method may be used to quickly generate public transport resource satisfaction degrees of residents in different regions at different periods of time based on big data.

### Embodiment 5

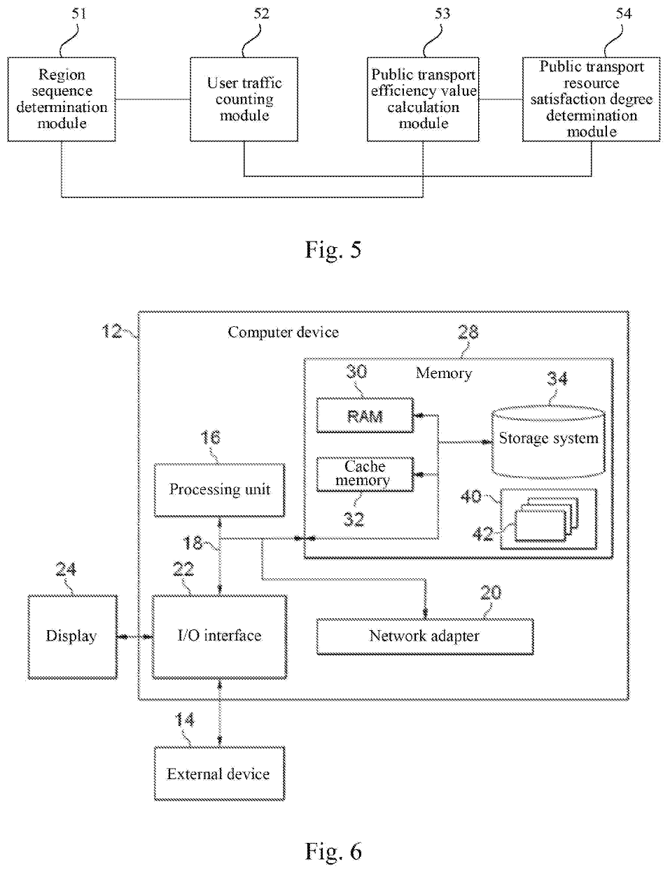

FIG. 5 is a schematic structural diagram of an apparatus for processing a position information according to an embodiment of the present disclosure. The apparatus is used to implement the method, may be located in a server or a workstation, and includes a region sequence determination module 51, a user traffic counting module 52, a public transport efficiency value calculation module 53 and a public transport resource satisfaction degree determination module 54.

The region sequence determining module 51 is configured for determining a region sequence according to a movement trajectory of a user, the region sequence including multiple region key-value pairs, and each region key-value pair representing two position regions through which the user passes.

The user traffic counting module 52 is configured for counting a user traffic between the two position regions included in the target region key-value pair, the target region key-value pair being any region key-value pair in the region sequence.

The public transport efficiency value calculation module 53 is configured for calculating a public transport efficiency value according to the target region key-value pair.

The public transport resource satisfaction degree determination module 54 is configured for determining a public transport resource satisfaction degree of the target region key-value pair according to the public transport efficiency value and the user traffic.

Further, the region sequence determination module 51 is configured for:

acquiring a movement trajectory of a user, the movement trajectory including a plurality of trajectory elements, and each trajectory element including coordinate information, time information and user information;

determining, according to the coordinate information, region information where the coordinate information is in;

generating a region key-value pair according to the time information and the region information; and

generating a region sequence of the user according to the region key-value pair and the user information.

Further, the region sequence determination module 51 is configured for:

receiving user positioning data sent by a terminal when a frequency at which the user operates the terminal reaches a threshold; and

updating the movement trajectory of the user according to the user positioning data.

Further, the user traffic counting module 52 is configured for:

determining whether a region key-value pair matching the target region key-value pair exists in a region sequence of other users; and

if the region key-value pair matching the target region key-value pair exists, counting to obtain a counting result, the counting result being used to indicate the number of users who have travel requirements for the target region key-value pair.

Further, the public transport efficiency value calculation module 53 is configured for:

determining public transport time and reference commuting time according to the two regions included in the target region key-value pair, the public transport time representing the time required to take a public transport means between the two regions, and the reference commuting time representing the fastest time required to take a transportation means between the two regions; and

determining a public transport efficiency value according to the public transport time and the reference commuting time.

Further, the public transport efficiency value calculation module 53 is configured for:

determining a public transport route and a reference commuting route according to a center point of the two regions included in the target region key-value pair;

determining public transport time according to the public transport route; and

determining reference commuting time according to the reference commuting route.

Further, the public transport resource satisfaction degree determination module 54 is configured for:

calculating the product of the public transport efficiency value and the user traffic; and

taking the product as a public transport resource satisfaction degree of the target region key-value pair.

According to the apparatus for processing a position information provided by the embodiment of the present disclosure, the region sequence determination module 51 determines a region sequence according to a movement trajectory of a user, the region sequence including multiple region key-value pairs; the user traffic counting module 52 counts a user traffic between two position regions included in a target region key-value pair; the public transport efficiency value calculation module 53 calculates a public transport efficiency value according to the target region key-value pair; and the public transport resource satisfaction determination module 54 determines a public transport resource satisfaction degree of the target region key-value pair according to the public transport efficiency value and the user traffic. A computer processes and calculates based on collected user trajectories without the need for investigators to visit, thereby reducing labor costs. In addition, the user trajectories are processed to obtain a public transport resource satisfaction degree between two regions, and the data processing by the computer may avoid manual statistics of investigation results, thereby improving the processing speed. Meanwhile, since the public transport resource satisfaction degree is determined according to the user trajectories, it is possible to calculate a traffic demand degree using real behavior data, thereby improving the accuracy of the public transport resource satisfaction degree.

The apparatus for processing a position information provided by the embodiment of the present disclosure may execute the method for processing a position information provided by any embodiment of the present disclosure, and has corresponding function modules for executing the method as well as beneficial effects.

### Embodiment 6

FIG. 6 is a schematic structural diagram of a computer device according to embodiment 6 of the present disclosure. FIG. 6 shows a block diagram of an exemplary computer device 12 which is applicable to implement the embodiments of the present disclosure. The computer device 12 shown in FIG. 6 is only illustrative and is not intended to suggest any limitation as to the functionality or scope of use of the embodiments of the present disclosure.

Referring to FIG. 6, the computer device 12 is shown in the form of a general-purpose computing device. The components of the computer device 12 may include, but not limited to, one or more processors or processing units 16, a system memory 28 and a bus 18 that couples various system components including a system memory 28 and a processing unit 16.

The bus 18 represents one or more of several types of bus structures, including a memory bus or a memory controller, a peripheral bus, an accelerated graphics port, and a processor or a local bus using any of a variety of bus architectures. By way of example, such architectures include, but not limited to, an Industry Standard Architecture (ISA) bus, a Micro Channel Architecture (MAC) bus, an enhanced ISA bus, a Video Electronics Standards Association (VESA) local bus and a peripheral component interconnects (PCI) bus.

The computer device 12 typically includes a variety of computer system-readable media. Such media may be any available media that are accessible by the computer device 12, and include both volatile and non-volatile media, removable and non-removable media.

The system memory 28 may include computer system readable media in the form of volatile memory, such as a random access memory (RAM) 30 and/or a cache memory 32. The computer device 12 may further include other removable/non-removable, volatile/nonvolatile computer system storage media. By way of example only, the storage system 34 may be provided for reading from and writing to a non-removable, non-volatile magnetic medium (not shown in FIG. 6, commonly referred to as a “hard drive”). Although not shown in FIG. 6, a magnetic disk drive for reading from and writing to a removable non-volatile magnetic disk, for example, a “floppy disk”, and an optical disk drive for reading from and writing to a removable, non-volatile optical disk such as CD-ROM, DVD-ROM or other optical media may be provided. In such instances, each drive may be connected to the bus 18 by one or more data media interfaces. The memory 28 may include at least one program product having one set (for example, at least one) of program modules that are configured to carry out the functions of the embodiments of the present disclosure.

A program/utility 40, having one set (at least one) of program modules 42, may be stored in the memory 28 by way of example. Such program modules 42 include, but are not limited to, an operating system, one or more application programs, other program modules, and program data. Each of the operating system, one or more application programs, other program modules, and program data or some combination thereof, may include an implementation of a networking environment. The program modules 42 generally carry out functions and/or methodologies of embodiments of the present disclosure.

The computer device 12 may also communicate with one or more external devices 14 such as a keyboard, a pointing device, a display 24; one or more devices that enable a user to interact with the computer device 12; and/or any device (e.g., a network card, a modem) that enables the computer device 12 to communicate with one or more other computing devices. Such communication may occur via input/output (I/O) interfaces 22. Still yet, the computer device 12 may communicate with one or more networks such as a local region network (LAN), a wide region network (WAN), and/or a public network, for example the Internet, via a network adapter 20. As depicted, the network adapter 20 communicates with other components of the computer device 12 via the bus 18. It should be understood that although not shown, other hardware and/or software components may be used in conjunction with the computer device 12. Examples include, but not limited to: microcode, device drivers, redundant processing units, external disk drive arrays, RAID systems, tape drives, and data backup storage systems.

The processing unit 16 executes various functional applications and data processing by running a program stored in the system memory 28, for example, implementing a method for processing a position information provided by an embodiment of the present disclosure.

### Embodiment 7

Embodiment 7 of the present disclosure also provides a computer-readable storage medium storing a computer program therein. The program, when executed by a processor, implements the method for processing a position information according to the embodiments above.

The computer storage medium according to the embodiments of the present disclosure may adopt any combination of one or more computer-readable media. The machine readable medium may be a computer readable signal medium or a computer readable storage medium. An example of the computer readable storage medium may include, but is not limited to, electronic, magnetic, optical, electromagnetic, infrared, or semiconductor systems, apparatus, elements, or a combination of any of the above. A more specific example of the computer readable storage medium may include, but is not limited to: an electrical connection with one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which may be used by a command execution system, apparatus, or element or incorporated thereto.

In some embodiments of the present disclosure, the computer readable signal medium may include data signal in the base band or propagating as parts of a carrier, in which carries computer readable program codes are carried. The propagating data signal may take various forms, including but not limited to: an electromagnetic signal, an optical signal or any suitable combination of the above. The computer readable signal medium may also be any computer readable medium except for the computer readable storage medium. The computer readable medium is capable of transmitting, propagating or transferring programs for use by or used in combination with, a command execution system, apparatus or element.

The program codes contained on the computer readable medium may be transmitted with any suitable medium including but not limited to: wireless, wired, optical cable, RF medium, or any suitable combination of the above.

A computer program code for executing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any type of network, including a local region network (LAN) or a wide region network (WAN), or may be connected to an external computer (for example, connected through Internet using an Internet service provider).

It should be noted that the above are only the preferred embodiments of the present disclosure and applied technical principles applied therein. It will be understood that the present disclosure is not limited to the particular embodiments described herein, but is capable of various modifications, rearrangements and substitutions as will now become apparent to those skilled in the art without departing from the scope of the invention. Therefore, although the present disclosure has been described in detail by means of the embodiments above, the present disclosure is not limited to such embodiments, and the present disclosure may include more other equivalent embodiments without departing from the concept of the present disclosure. The scope of the present disclosure is determined by the scope of the appended claims.

What is claimed is:

1. A method for processing a position information, comprising:
determining a region sequence according to a movement trajectory of a user, the region sequence comprising multiple region key-value pairs, and each region key-value pair representing two position regions through which the user passes;
counting a user traffic between the two position regions comprised in the target region key-value pair, the target region key-value pair being any region key-value pair in the region sequence;
calculating a public transport efficiency value according to the target region key-value pair; and
determining a public transport resource satisfaction degree of the target region key-value pair according to the public transport efficiency value and the user traffic.

2. The method for processing a position information according to claim 1, wherein the determining a region sequence according to a movement trajectory of a user comprises:
acquiring a movement trajectory of a user, the movement trajectory comprising a plurality of trajectory elements, and each trajectory element comprising a coordinate information, a time information and a user information;
determining, according to the coordinate information, a region information where the coordinate information is in;
generating a region key-value pair according to the time information and the region information; and
generating a region sequence of the user according to the region key-value pair and the user information.

3. The method for processing a position information according to claim 2, wherein the acquiring a movement trajectory of a user comprises:
receiving user positioning data sent by a terminal when a frequency at which the user operates the terminal reaches a threshold; and
updating the movement trajectory of the user according to the user positioning data.

4. The method for processing a position information according to claim 1, wherein the counting a user traffic between the two position regions comprised in the target region key-value pair comprises:
determining whether a region key-value pair matching the target region key-value pair exists in a region sequence of other users; and
if the region key-value pair matching the target region key-value pair exists, counting to obtain a counting result, the counting result being used to indicate a number of users who have travel requirements for the target region key-value pair.

5. The method for processing a position information according to claim 1, wherein the calculating a public transport efficiency value according to the target region key-value pair comprises:
determining a public transport time and a reference commuting time according to the two regions comprised in the target region key-value pair, the public transport time representing a time required to take a public transport means between the two regions, and the reference commuting time representing a fastest time required to take a transportation means between the two regions; and
determining a public transport efficiency value according to the public transport time and the reference commuting time.

6. The method for processing a position information according to claim 5, wherein the determining a public transport time and a reference commuting time according to the two regions comprised in the target region key-value pair comprises:
determining a public transport route and a reference commuting route according to a center point of the two regions comprised in the target region key-value pair;
determining a public transport time according to the public transport route; and
determining a reference commuting time according to the reference commuting route.

7. The method for processing a position information according to claim 1, wherein the determining a public transport resource satisfaction degree of the target region key-value pair according to the public transport efficiency value and the user traffic comprises:
calculating a product of the public transport efficiency value and the user traffic; and
taking the product as a public transport resource satisfaction degree of the target region key-value pair.

8. An apparatus for processing a position information, comprising:
at least one processor; and
a memory storing instructions, wherein the instructions when executed by the at least one processor, cause the at least one processor to perform operations, the operations comprising:
determining a region sequence according to a movement trajectory of a user, the region sequence comprising multiple region key-value pairs, and each region key-value pair representing two position regions through which the user passes;
counting a user traffic between the two position regions comprised in the target region key-value pair, the target region key-value pair being any region key-value pair in the region sequence;
calculating a public transport efficiency value according to the target region key-value pair; and
determining a public transport resource satisfaction degree of the target region key-value pair according to the public transport efficiency value and the user traffic.

9. A non-transitory computer readable storage medium, storing a computer program, wherein the program when executed by a processor causes the processor to perform operations, the operations comprising:
determining a region sequence according to a movement trajectory of a user, the region sequence comprising multiple region key-value pairs, and each region key-value pair representing two position regions through which the user passes;
counting a user traffic between the two position regions comprised in the target region key-value pair, the target region key-value pair being any region key-value pair in the region sequence;
calculating a public transport efficiency value according to the target region key-value pair; and
determining a public transport resource satisfaction degree of the target region key-value pair according to the public transport efficiency value and the user traffic.
